(19) United States
(12) Patent Application Publication
(10) Pub. No.: US 2024/0145163 A1
(43) Pub. Date: May 2, 2024

(54) TRANSFORMER

(71) Applicant: GaNrich Semiconductor Corporation, Hsinchu City (TW)

(72) Inventors: Chiao FU, Hsinchu City (TW); Yi-Chao LIN, Hsinchu City (TW); Yao-Zhong LIU, Hsinchu City (TW); Jia-Tay KUO, Hsinchu City (TW)

(21) Appl. No.: 18/382,360

(22) Filed: Oct. 20, 2023

(30) Foreign Application Priority Data
Oct. 28, 2022 (TW) 111141057

(51) Int. Cl. H01F 27/32; H01F 27/36

(52) U.S. Cl. CPC H01F 27/325; H01F 27/36; H01F 38/42

(57) ABSTRACT

A transformer includes a bobbin and a plurality of coils wound on the bobbin. The plurality of coils includes a first primary coil; a second primary coil, located above the first primary coil and electrically connected to the first primary coil; a secondary coil, located between the first primary coil and the second primary; a first auxiliary coil, located above the second primary coil; and a second auxiliary coil, located on the first auxiliary coil and electrically connected to the first auxiliary coil. A turn number of the first auxiliary coil is greater than a turn number of the second auxi

### CROSS-REFERENCE TO RELATED APPLICATIONS

This disclosure claims the right of priority of TW Application No. 111141057 filed on Oct. 28, 2022, and the content of which is hereby incorporated by reference in its entirety.

### BACKGROUND

### Technical Field

The present disclosure relates to a transformer, and more particularly, to a flyback transformer with an auxiliary winding.

### Description of the Related Art

In the current consumer electronics market, fast charging is a common requirement. Gallium nitride series (GaN series) materials, which have a wide band gap and high saturation rate, are suitable for high-power and high-frequency chargers. Therefore, designing a high-frequency transformer that balances output efficiency and temperature has become one of the goals in the industry.

### SUMMARY

The present disclosure provides a transformer, which can balance output efficiency and temperature when operating at the high frequency.

According to some embodiments of the present disclosure, a transformer is disclosed. The transform includes a bobbin and a plurality of coils wound on the bobbin. The plurality of coils includes a first primary coil; a second primary coil, located above the first primary coil, and electrically connected to the first primary coil; a secondary coil, located between the first primary coil and the second primary coil; a first auxiliary coil, located above the second primary coil; and a second auxiliary coil, located above the first auxiliary coil, and electrically connected the first auxiliary coil, wherein a turn number of the first auxiliary coil is larger than a turn number of the second auxiliary coil.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a flyback transformer according to an embodiment of the present disclosure.

FIG. 2 is a schematic diagram of a winding method of the plurality of coils of the flyback transformer according to an embodiment of the present disclosure.

FIG. 3 is a schematic diagram of an isolated flyback converter according to an embodiment of the present disclosure.

### DETAILED DESCRIPTION OF THE EMBODIMENTS

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. “Approximately” means that within the acceptable error range, a person with ordinary knowledge in the field can solve the technical problem within a certain error range and basically achieve the technical effect. Also, the term “couple” is intended to mean either an indirect or direct, wired or wireless electrical connection.

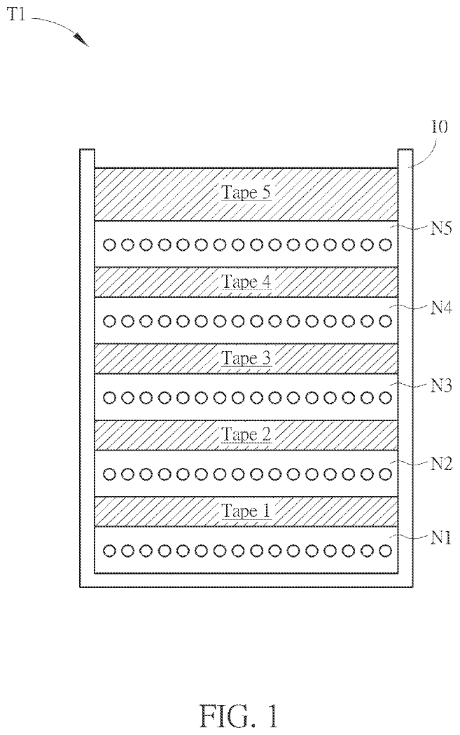

Please refer to FIG. 1. FIG. 1 is a schematic diagram of a flyback transformer T1 according to an embodiment of the present disclosure. The flyback transformer T1 includes a bobbin 10 and a plurality of coils wound on the bobbin 10. The plurality of coils includes a first primary coil N1, a secondary coil N2, a second primary coil N3, a first auxiliary coil N4 and a second auxiliary coil N5. The first primary coil N1 is a bottom layer, and the second primary coil N3 is located above the first primary coil N1 and electrically connected to the first primary coil N1. The secondary coil N2 is located between the first primary coil N1 and the second primary coil N3, the first auxiliary coil N4 is located above the second primary coil N3, and the second auxiliary coil N5 is located above the first auxiliary coil N4 and electrically connected to the first auxiliary coil N4. In addition, insulating layers Tape1, Tape2, Tape3, Tape4 are wound between each of the coils, and an insulating layer Tape5 is wound above the second auxiliary coil N5. In an embodiment, the material of each of the insulating layers Tape1, Tape2, Tape3, Tape4, and Tape5 may be a tape, a resin or an insulating paper, but is not limited thereto. In an embodiment, a thickness of the insulating layer Tape5 is more than one time of a thickness of each of the other insulating layers Tape1, Tape2, Tape3, Tape4. In other words, the insulating layer Tape5 may include more tape layers than anyone of the other insulating layers, so as to ensure sufficient insulation of the outermost layer of the flyback transformer T1. The insulating layers hide the above-mentioned coils inside by a closed winding method to prevent the wires from being exposed.

In another embodiment, the flyback transformer T1 may further include a first shielding layer and a second shielding layer, wherein the first shielding layer is located between the first primary coil N1 and the secondary coil N2, and the second shielding layer is located between the second primary coil N3 and the secondary coil N2. In another embodiment, the insulating layers are further wound between the first shielding layer and the first primary coil N1, the secondary coil N2, and/or the second primary coil N3, or wound between the second shielding layer and the first primary coil N1, the secondary coil N2, and/or the second primary coil N3. The first shielding layer and the second shielding layer are not shown in FIG. 1, but in the following table 1, the first shielding layer is referred to as E1, the second shielding layer is referred to as E2.

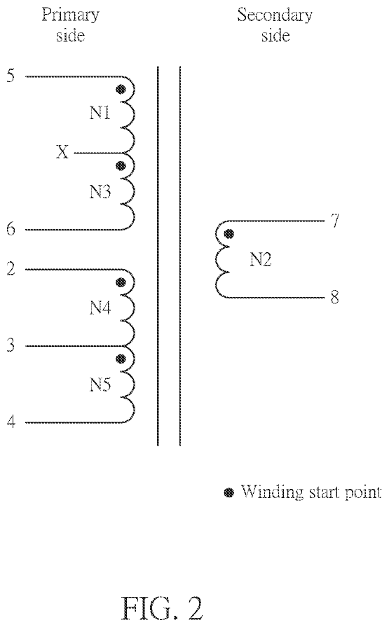

Please refer to FIG. 2. FIG. 2 is a schematic diagram of a winding method of the plurality of coils of the flyback transformer T1 according to an embodiment of the present disclosure. The pin 5 of the flyback transformer T1 is a winding starting point of the first primary coil N1, and the winding of the first primary coil N1 is to end at the position X (usually the top of the transformer or any empty pin). A winding of the second primary coil N3 is started at the position X, and ended at the pin 6. It can be seen that a winding direction of the first primary coil N1 and a winding direction of the second primary coil N3 are the same. Similarly, a winding of the secondary coil N2 is started at the pin 7 of the flyback transformer T1, and the pin 8 is a winding end point; the pin 2 of the flyback transformer T1 is a winding start pint of the first auxiliary coil N4, and the pin 3 is a winding end point of the first auxiliary coil N4; and the pin 3 of the flyback transformer T1 is also a winding start point of the second auxiliary coil N5, and the pin 4 is a winding end point of the second auxiliary coil N5. In an embodiment, the first shielding layer and the second shielding layer are respectively between the first primary coil N1 and the secondary coil N2, and between the second primary coil N3 and the secondary coil N2. A winding start point of the first shielding layer and a winding start point of the second shielding layer are floating, and the pin 4 is a winding end point of the first shielding layer and the second shielding layer. By winding the first shielding layer and the second shielding layer, electromagnetic interference (EMI) between a primary side and a secondary side of the flyback transformer T1 may be reduced.

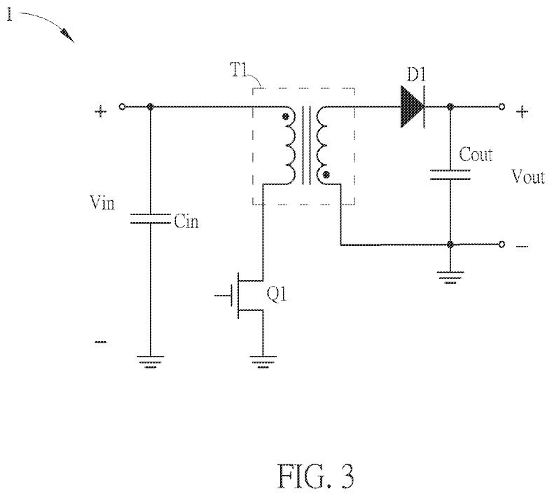

Please refer to FIG. 3. FIG. 3 is a schematic diagram of an isolated flyback converter 1 according to an embodiment of the present disclosure. The isolated flyback converter 1 includes a switching transistor Q1, the flyback transformer T1, a diode DI, an input capacitor Cin and an output capacitor Cout. Specifically, by determining an input voltage Vin and an output voltage Vout, the isolated flyback converter 1 may operate in a steady state mode.

In an embodiment, the switching transistor Q1 in the isolated flyback converter 1 may be a high power transistor, a high voltage transistor, a high frequency transistor, etc. made of III-V compounds. In addition, for high-power and high-frequency applications, the switching transistor Q1 may be a gallium nitride high electron mobility transistor (GaN-HEMT). GaN series materials are suitable for high-power and high-frequency applications due to the wide energy band gap and high saturation rate. In an embodiment, the switching transistor Q1 is an enhancement-mode GaN-HEMT. In another embodiment, the switching transistor Q1 adopts an enhancement-mode metal oxide semiconductor field effect transistor (E-mode MOSFET) and a depletion-mode GaN-HEMT. The flyback transformer T1 includes the flyback transformer disclosed in any one of the above embodiments. In an embodiment, in order to balance the output efficiency and temperature when the isolated flyback converter 1 operates at high frequency in high-power and high-frequency applications, the present disclosure utilizes an auxiliary coil in the flyback transformer T1. When the isolated flyback converter 1 is used to output different voltages to different systems, a supply voltage on a primary side may need to be adjusted, for example, by adjusting the turn number of the first auxiliary coil N4 and the turn number of the second auxiliary coil N5, to correspond to different supply voltages.

In detail, the winding method of the plurality of coils in the embodiment of the present disclosure may refer to the following rules, so that the isolated flyback converter 1 may operate at a high frequency while balancing the output efficiency and temperature. In an embodiment, the turn number of the second primary coil N3 is different from the turn number of the first primary coil N1. In another embodiment, the sum of the turn number of the first primary coil N1 and the turn number of the second primary coil N3 may be 4 to 8 times the turn number of the secondary coil N2. In an embodiment, the turn number of the secondary coil N2 may be smaller than the turn number of the first primary coil N1 and the turn number of the second primary coil N3. The turn number of the first auxiliary coil N4 may be at least 3 times greater than the turn number of the second auxiliary coil N5. The turn number of the first shielding layer E1 and the turn number of the second shielding layer E2 may be greater than at least one of the turn number of the first primary coil N1, the turn number of the second primary coil N3 and the turn number of the secondary coil N2. A wire diameter of the first shielding layer E1 and a wire diameter of the second shielding layer E2 may be smaller than a wire diameter of the first primary coil N1, a wire diameter of the second primary coil N3 and a wire diameter of the secondary coil N2. In an embodiment, the aforementioned coils may have the same or different wire strand number. The material of each coil includes a polyamine enameled copper wire (UEW) stranded wire, a Litz wire or TIW triple insulated single core wire. The materials of the above-mentioned coils may be the same or different.

For example, please refer to table 1. Table 1 is the winding method of the plurality of coils according to an embodiment of the present disclosure. For example, two ends of the first primary coil N1 are respectively coupled to the pin 5 and the position X; one end of the first shielding layer E1 is coupled to the pin 4, and another end of the first shielding layer E1 is floating. Since the flyback transformer T1 of the present disclosure is used in high frequency applications, for example, the operating frequency is 200 kHz-250 kHz, the output voltage is 90 Vac-265 Vac, the output supports a single voltage 20-24V, and has various output specifications: 5V@3 A, 9V@3 A, 12V@3 A, 15V@3 A, 20V@3.25 A, etc. The wire strand number of the first primary coil N1 and the wire strand number of the second primary coil N3 may include 1-50 strands (P), which is adjusted according to the system wattage and the operation requirements. For example, each of the first primary coil N1 and the second primary coil N3 may include a Litz wire, and the Litz wires are twisted with 15 turns and 14 turns of polyamine enameled copper wire (UEW) including 12 strands (12P) respectively. The wire diameter of each coil may be 0.05-0.5 mm, such as 0.12 mm. The secondary coil N2 may be wound 5 turns with 80 strands (80P) of triple insulated wire (TIW) with a wire diameter of 0.1 mm. In this way, the first primary coil N1 and the second primary coil N3 are wound to conforms to following rules of: the turn number of the second primary coil N3 is different from the turn number of the first primary coil N1; the sum of the turn number of the first primary coil N1 and the turn number of the second primary coil N3 is 4 to 8 times the turn number of the secondary coil N2; and the turn number of the secondary coil N2 is smaller than the turn number of the first primary coil N1 and the turn number of the second primary coil N3. Therefore, the influence of the skin effect when the flyback transformer T1 operates at a high frequency may be reduced. The winding method of other coils in table 1 also conforms to the above rules, and will not be repeated here.

TABLE 1

| | | | Turn | | |
|---|---|---|---|---|---|
| Coil | End | Wire | number | Insulating layer | |
| N1 | 5-X | LITZ(UEW) 0.12 mm*12P | 15 | 1 layer | |
| E1 | ---4 | UEW 0.13 mm*2p | 28 | 1 layer | |
| N2 | 7-8 | TIW-M 0.1 mm*80p | 5 | 2-3 | layers |
| E2 | ---4 | UEW 0.13 mm*2p | 28 | 1 layer | |
| N3 | X-6 | LITZ(UEW) 0.12 mm*12P | 14 | 1 layer | |
| N4 | 2-3 | UEW 0.23 mm*1p | 15 | 1 layer | |
| N5 | 3-4 | UEW 0.23 mm*1p | 4 | 2 | layers |

In summary, the winding method of the plurality of coils in the flyback transformer of the present disclosure conforms to multiple rules, which may make the operation of the isolated flyback converter comply with the safety regulations and the fast charging power delivery at high frequency, and take into account both the output efficiency and the temperature.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A transformer, comprising:
a bobbin; and
a plurality of coils, wound on the bobbin, wherein the plurality of coils comprises:
a first primary coil;
a second primary coil, located above the first primary coil, and electrically connected to the first primary coil;
a secondary coil, located between the first primary coil and the second primary coil;
a first auxiliary coil, located above the second primary coil; and
a second auxiliary coil, located above the first auxiliary coil, and electrically connected the first auxiliary coil, wherein a turn number of the first auxiliary coil is greater than a turn number of the second auxiliary coil.

2. The transformer of claim 1, further comprising:
a first shielding layer and a second shielding layer, wherein the first shielding layer is located between the first primary coil and the secondary coil, and the second shielding layer is located between the second primary coil and the secondary coil.

3. The transformer of claim 2, wherein a wire diameter of the first shielding layer and a wire diameter of the second shielding layer are smaller than a wire diameter of the first primary coil, a wire diameter of the second primary coil and a wire diameter of the secondary coil.

4. The transformer of claim 2, wherein the turn number of the first shielding layer and the turn number of the second shielding layer are greater than at least one of the turn number of the first primary coil, the turn number of the second primary coil and the turn number of the secondary coil.

5. The transformer of claim 1, wherein the turn number of the first auxiliary coil is at least three times greater than the turn number of the second auxiliary coil.

6. The transformer of claim 1, wherein the turn number of the secondary coil is smaller than the turn number of the first primary coil and the turn number of the second primary coil.

7. The transformer of claim 1, wherein a winding direction of the second primary coil is the same as a winding direction of the first primary coil.

8. The transformer of claim 1, wherein the turn number of the second primary coil is different from the turn number of the first primary coil.

9. The transformer of claim 1, wherein a sum of the turn number of the first primary coil and the turn number of the second primary coil is four to eight times the turn number of the secondary coil.
